(19) United States
(12) Patent Application Publication
(10) Pub. No.: US 2022/0396028 A1
(43) Pub. Date: Dec. 15, 2022

(54) Elongated Nozzle FDM 3D printer

(71) Applicant: Sergey Julius Glimis, Elkins Park, PA (US)

(72) Inventor: Sergey Julius Glimis, Elkins Park, PA (US)

(21) Appl. No.: 17/838,026

(22) Filed: Jun. 10, 2022

Related U.S. Application Data
(60) Provisional application No. 63/210,066, filed on Jun. 13, 2021.

(51) Int. Cl. B29C 64/209; B29C 64/295; B33Y 30/00

(52) U.S. Cl. CPC B29C 64/209; B29C 64/295; B33Y 30/00

(57) ABSTRACT

The present invention relates to apparatus and methods for producing three-dimensional objects and auxiliary systems used in conjunction with the aforementioned apparatus and methods. An apparatus that extrudes melted material through an elongated nozzle which may or may not have divided sections within the elongated nozzle allowing independent extrusion of each. An FDM 3D printer comprising an elongated nozzle and hot end, the extruder assembly and the elongated filament or the use of traditional filament with many divided sections in the elongated nozzle.

### FIELD AND BACKGROUND OF THE INVENTION

The present invention and embodiments of said invention in general relate to an apparatus designed and used to create three dimensional objects. In particular it relates to an FDM 3D printer for users to be able to 3D print objects.

Desktop 3D printers like the Ender 3 have been used in homes and businesses for many years. The Ender 3 and machines like it relate to the original FDM patent filed in 1990. Since patent U.S. Pat. No. 5,121,329A was filed, few significant advancements to FDM 3D printing technology have been made.

The most significant advancement in FDM technology is the use of multiple nozzles. Chinese patent CN105881914B shows an apparatus with multiple nozzles.

### SUMMARY OF THE INVENTION

All embodiments of the present invention are related to an FDM 3D printer with an elongated nozzle, which includes the elongated nozzle and hot end, the extruder assembly and the elongated filament. The other main elements are things that traditional FDM 3D printers use and those things may or may not not change much at all, those things include the framing, traditional filament and electrical systems that control the printer.

There has thus been outlined, rather broadly, some of the features of the elongated nozzle FDM 3D printer in order that the detailed description thereof may be better understood, and in order that the present contribution to the art may be better appreciated. There are additional features of the elongated nozzle FDM 3D printer that will be described hereinafter and that will form the subject matter of the claims appended hereto. In this respect, before explaining at least one embodiment of the elongated nozzle FDM 3D printer in detail, it is to be understood that the elongated nozzle FDM 3D printer is not limited in its application to the details of construction or to the arrangements of the components set forth in the following description(s) or illustrated in the drawings. The elongated nozzle FDM 3D printer is capable of other embodiments and of being practiced and carried out in various ways. Also, it is to be understood that the phraseology and terminology employed herein are for the purpose of the description and should not be regarded as limiting.

One object of the invention is to complete prints faster than traditional FDM 3D printers.

Another object is to produce stronger prints than traditional FDM 3D printers would generally produce due to the time required to use full infill.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Embodiments will become more fully understood from the detailed description given herein below and the accompanying drawings, wherein like elements are represented by like reference characters, which are given by way of illustration only and thus are not limitative of the embodiments herein.

FIG. 1: FIG. 1 is an exploded lower perspective that depicts the elongated nozzle (1) and hot end assembly. This is a blown up depiction and some of the hot end assembly is cut off. The elongated section of material (2) flowing out of the elongated nozzle (1) can be clearly seen. A heat sink (12), heater block (3), heating element (19), heat break (4) and build surface (5) are also visible.

FIG. 2: FIG. 2 is an exploded lower perspective view that depicts the elongated nozzle (1) and hot end assembly. This is a blown up depiction and some of the hot end assembly is cut off. The elongated section of material (2) flowing out of the elongated nozzle (1) can be clearly seen. A heater block (3), heating element (19), heat break (4) and build surface (5) are also visible.

FIG. 3: FIG. 3 is an exploded upper perspective view that depicts the extruder assembly for the first embodiment. This Figure shows an extruder assembly specialized for pushing an elongated filament through the elongated nozzle (1). An elongated filament roll holder (7) is depicted as well as an extruder feed gear (6), two extruder motors (9) and a filament feed guide (21). An X-axis track (8) that the extruder assembly is on is also depicted.

FIG. 4: FIG. 4 is an exploded upper perspective view that depicts the first embodiment's extruder assembly on it's X-axis track (8) and the elongated nozzle (1) and hot end in front, on its own separate X-axis track (8). An optional direct drive extruder (11) for an optional on board traditional nozzle (14) and hot end is also depicted. The traditional nozzle (14) is out of view in this Figure and could be on the other side of the hot end assembly like depicted in FIG. 9 or could be beside the elongated nozzle (1) and hot end (which would make it visible in this Figure), or it could be in another place.

FIG. 5: FIG. 5 is a lower perspective view that depicts most of the first embodiment from behind. An extruder assembly, Z-axis rods (25) and elongated filament roll holder (7) are visible.

FIG. 6: FIG. 6 is an exploded lower perspective view of looking up the first embodiment's elongated nozzle (1). The elongated nozzle (1) in this embodiment has no separators (17) thus only one section (16). This is also how the fourth embodiment's elongated nozzle (1) would look from below.

FIG. 7: FIG. 7 is a cross section of the elongated nozzle (1) from the first embodiment. No separators (17) are present as depicted, thus only one section (16). This figure is also what the fourth embodiment's elongated nozzle (1) cross section would look like.

FIG. 8: FIG. 8 is an exploded lower perspective view that depicts what a fan unit might look like on the elongated nozzle (1) and hot end assembly. An X-axis track (8) it resides on is also shown. Hot end fans (12) and a layer fan air duct/channel (20) are also depicted.

FIG. 9: FIG. 9 is an exploded lower perspective view that depicts both the layer fans (13) and hot end fans (12). It also depicts the optional traditional nozzle (14) and hot end. The optional traditional nozzle's extruder (11) is also depicted. A traditional nozzle (14) can fill in certain detailed sections if the elongated nozzle (1) cannot due to being too large.

FIG. 10: FIG. 10 is a cross section of the second embodiment's elongated nozzle (1) and hot end. One separator (17) in the middle is depicted, thus there are two sections (16). A heater block (3), heat sink (18), elongated tube coupling (22) and heating element (19) are depicted as well.

FIG. 11: FIG. 11 is an exploded lower perspective view from under the second embodiment's elongated nozzle (1). A separator (17) in the middle can be seen. A heater block (3) can be seen as well.

FIG. 12: FIG. 12 is an exploded upper perspective view that depicts the extruder assembly for the second embodiment. It has two extruder feed gears (6) and two filament feed guides (21). It also has two extruder motors (9). One of the two extruder motors (9) is visible.

FIG. 13: FIG. 13 is a cross section of the third embodiment's elongated nozzle (1) and hot end. 68 sections (16) with a separator (17) between each one is depicted, however this embodiment can have any number of sections (16) and separators (17).

FIG. 14: FIG. 14 is an exploded lower perspective view that depicts a large amount of divided sections inside the elongated nozzle (1) looking up from below it. There are 68 separate sections depicted but this embodiment could have any number of sections. This Figure depicts the elongated nozzle (1) for the third embodiment.

FIG. 15: FIG. 15 is an exploded upper perspective view that depicts the extruder array for the third embodiment. Each extruder connects up to the top of the hot end where there are an array of ports. These ports stem out of the elongated tube coupling (22). There are the same amount of ports as extruders in the array. Only 4 are connected in the Figure to show how it might also look when some are yet to be connected.

FIG. 16: FIG. 16 is an upper perspective view that depicts the extruder array used for the third embodiment. A few of the connection tubes (15) are going over to the top of elongated nozzle (1) and hot end assembly which is out of view.

FIG. 17: FIG. 17 is an upper perspective view that depicts a roll of filament as it might look. Needless to say it looks different than a spool of filament that most traditional FDM 3D printers use.

FIG. 18: FIG. 18 is an upper perspective view that depicts what filament that is used with the second embodiment might look like. The roll holder has two unconnected rolls on it. These two unconnected rolls allow extrusion of either roll or both together.

FIG. 19: FIG. 19 is an upper perspective view that depicts a traditional filament spool.

FIG. 20: FIG. 20 is an exploded upper perspective view that depicts the extruder assembly for the fourth embodiment of the printer. An extruder feed gear (6) and filament feed guide (21) are mounted in the bottom of the extruder assembly. A channel that leads down to the elongated connection tube (10) is also visible.

FIG. 21: FIG. 21 is an exploded upper perspective view that depicts the extruder assembly for the fourth embodiment. The extruder assembly is on it's own X-axis track (8) above the elongated hot end assembly on it's own separate X-axis track (8). The elongated connection tube (10) is depicted going from the extruder assembly, straight down to the top of the elongated hot end. The two rotation assemblies (23) would rotate in unison.

FIG. 22: FIG. 22 is an upper perspective view that depicts the top of the extruder assembly in the fourth embodiment. A filament roll holder (7) is depicted on the top of the machine's frame. The traditional filament spool holder (24) for an onboard traditional nozzle (14) is also depicted but wouldn't be present if no traditional nozzle (14) was present on the printer. Two parallel X-axis tracks (8) are depicted which the extruder assembly would slide on. One of the X-axis tracks (8) below, that the hot end assembly slides on is also visible not to be confused with the one above it.

FIG. 23: FIG. 23 is an exploded lower perspective that depicts the ports at the top of the elongated hot end in the third embodiment. The tubes (15) each go to an extruder in the extruder array. When all ports are connected to a tube (15) those tubes (15) would all go to an extruder in the array.

### DETAILED DESCRIPTION

Embodiments of the present invention are described below. It is, however, expressly noted that the present invention is not limited to these embodiments, but rather the intention is that variations, modifications, and equivalents that are apparent to the person skilled in the art are also included.

### A. Overview

Turning now descriptively to the drawings, in which similar reference characters denote similar elements throughout the several views, the figures illustrate 4 example embodiments comprising the elongated nozzle (1) and hot end, an extruder assembly as well as elongated filament. The other main elements are things that Traditional 3D printers use and those things may or may not change very much at all, those things include the framing/chassis, traditional spool filament and the electrical systems that control the printer.

### B. Elongated Nozzle and Hot End

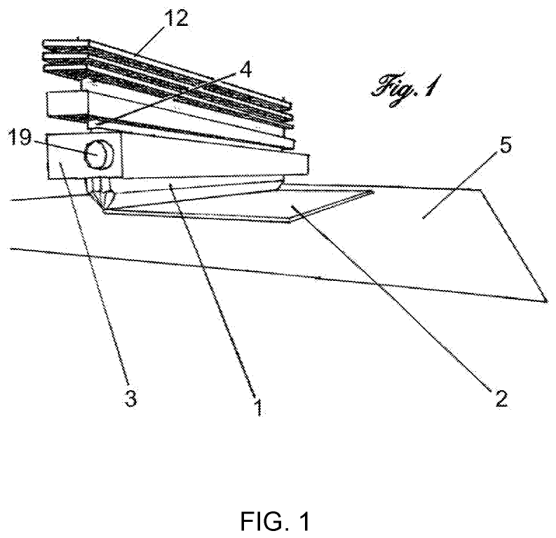

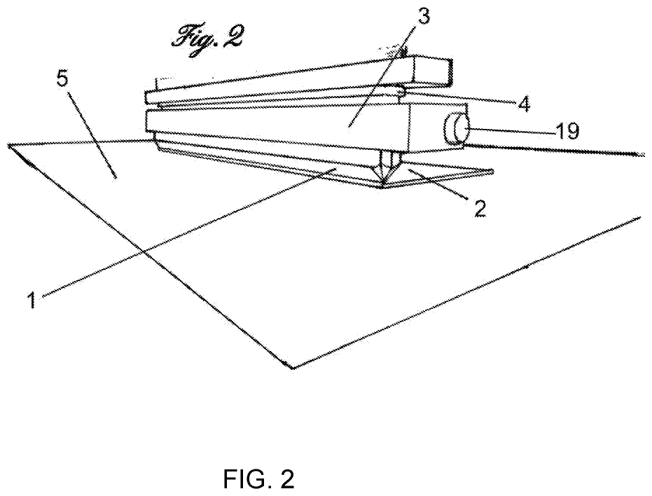

The elongated nozzle (1) has an elongated shape and allows a long section of material (2) to flow out of it at once. This elongated shape allows it to push out a long ribbon of material (2) like a paint brush stroke. If a person were tasked with filling in a large box on a piece of paper in less than a minute, they would probably elect to use a paint brush instead of a pencil. Traditional FDM 3D printers use tiny nozzles that have a nozzle opening about the size of a pencil tip. Many prints have large areas that must be filled in by going back and forth similar to using a pencil to color something in. With the elongated nozzle (1), a large uninterrupted section of a print layer can be filled in, in a few seconds. The elongated nozzle (1) and hot end are depicted in FIGS. 1, 2, 6 and 7. Other embodiments of the elongated nozzle (1) and hot end are depicted in the Figures.

The elongated nozzle (1) and hotend have an elongated shape and allow a long section of material (2) to flow out of the elongated nozzle (1) at once. This is like printing a ribbon of material instead of a line, think of a paint brush over a pencil. A traditional 0.4 mm 3D printer nozzle would be like a pencil while the elongated nozzle (1) is similar to a paint brush.

The assembly which the elongated hot end is mounted on could make use of a simple lifting mechanism that could lift the elongated nozzle (1) and hot end a few mm up farther from the print to prevent heat transfer. The lifting mechanism could use one or two servos or a different lifting mechanism.

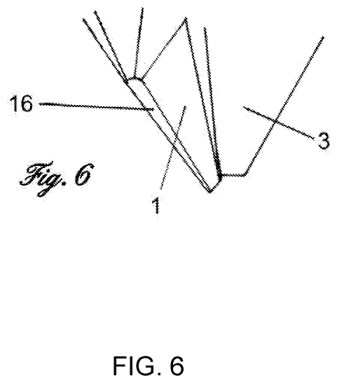

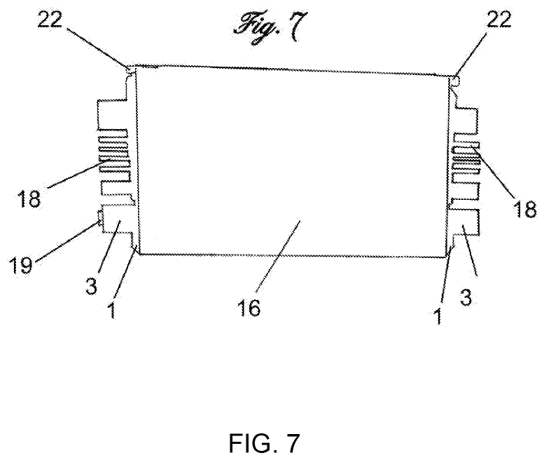

The elongated nozzle (1) may or may not have divided sections (16) within it which would allow separate extrusion for however many sections (16) it has, if any. This would allow the printer to control which sections (16) of the elongated nozzle (1) are extruding and which are not, when multiple inside sections (16) are present. The most basic embodiment of the elongated nozzle (1) is hollowed out inside and has no separated sections (16) as depicted in FIGS. 6 and 7. The hollow space/sections (16) inside the elongated nozzle (1) and hot end are marked as (16). The section separators (17) separate each section (16), these would likely be made of thin metal but could be made of any material. In any embodiment without separated sections (16), extrusion would push the material (2) through the entire elongated nozzle (1) collectively and no areas of the elongated nozzle (1) could be turned off; while other areas extrude. Either the whole elongated nozzle (1) is extruding material (2) or it isn't. In the embodiment of the elongated nozzle (1) that does have separated sections (16), a separate extruder would be needed for each section (16). The elongated nozzle (1) can come in any shape, degree of elongation, size and the elongated hot end may or may not make use of a heat sink (18), heater block (3), heat break (4), tube coupling/coupler (22), layer fans (13) and cooling fans (12). Some of these things are typically necessary in traditional FDM 3D printers and in this invention but if they ever become unnecessary due to technological advancements or other reasons, other systems can be used in their place. As well the separate sections (16) separated by the separators (17) may or may not be noticeable from the outside of the elongated nozzle (1), hot end and connection tube (10). As well any number of separate sections (16) can be used.

The heating element (19) would likely be a longer heating element (19) than traditional 3D printers use and would slide into a hole in the heater block (3) like traditional printers have but it would be longer, likely almost the length of the heater block (3) and elongated nozzle (1). This is to allow for even heat distribution across the elongated nozzle (1) and heater block (3). The heater block (3) may utilize 1 or multiple temperature sensors or may have none if for example a heating element that doesn't require a temperature sensor is used.

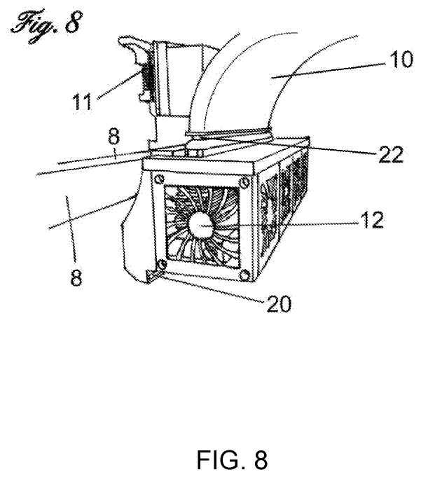

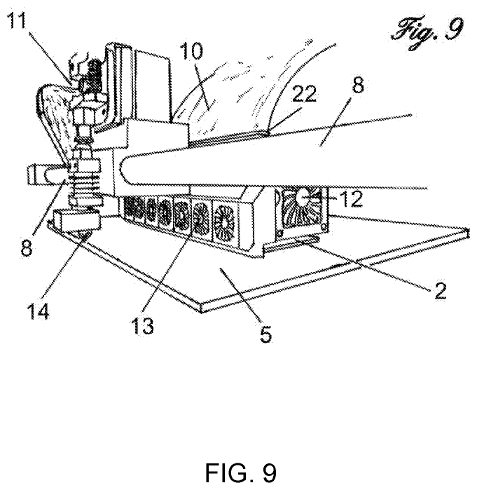

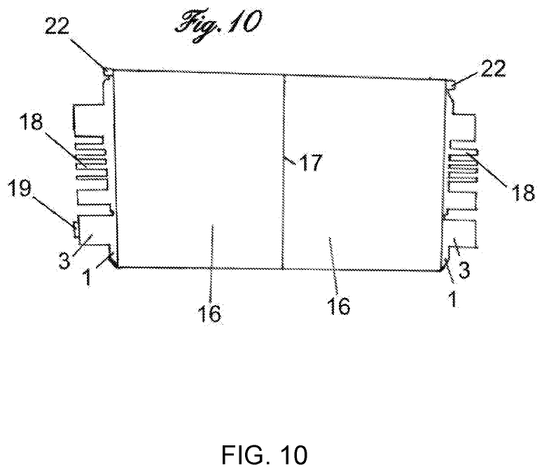

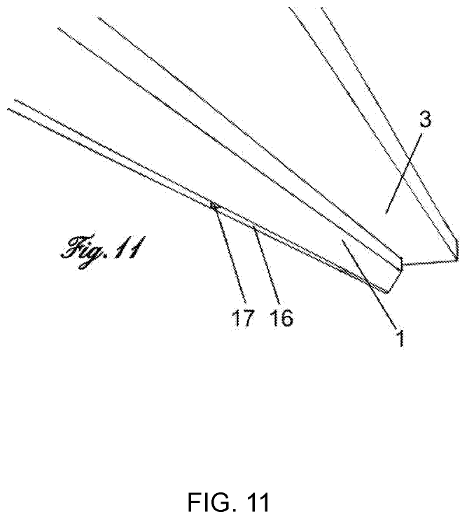

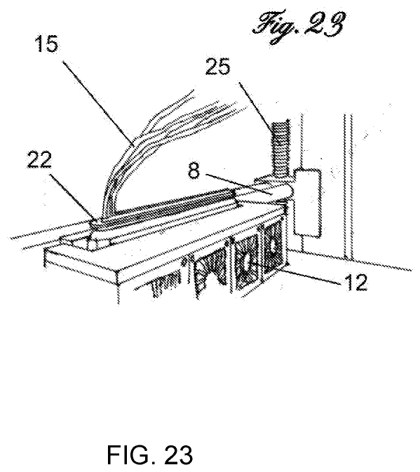

A fan system which could be mounted over the elongated hot end is depicted in FIGS. 8, 9 and 23. Both layer fans (13) with the layer fan air channel (20) and hot end fans (12) are depicted. The second embodiment of the elongated nozzle (1) and hot end has one separation (17) in the middle of the elongated nozzle (1) and hot end. This embodiment is depicted in FIGS. 10 and 11, this embodiment might be indistinguishable from the first embodiment (depicted in FIGS. 6 and 7) when you look at it from the outside. If you look up the elongated nozzle (1) you would see that one (the second embodiment) has a separator (17) in the middle (as depicted in FIG. 11), but other than that they may be hard to tell apart as they are in the Figures. The hot end and connection tube (10) might look identical to the first embodiment as depicted, except for a separation (17) in the middle of the tube (10), elongated nozzle (1) and hot end that are not visible in FIGS. 8 and 9. The separation (17) in the elongated nozzle (1) is visible in FIGS. 10 and 11. FIGS. 8 and 9 represent what both the first and second embodiments might look like from the perspectives shown in FIGS. 8 and 9. The inside of the elongated tube (10) that goes from the top of the hot end in the elongated tube coupling (22) to the extruder, would also have a separation inside it, but it may or may not be noticeable from the outside as it isn't in the FIGS. 8 and 9. Again these figures represent how the elongated tube (10) may look in both the first and second embodiments from those views.

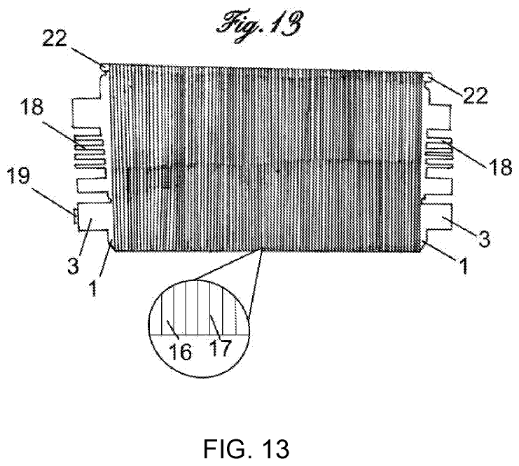

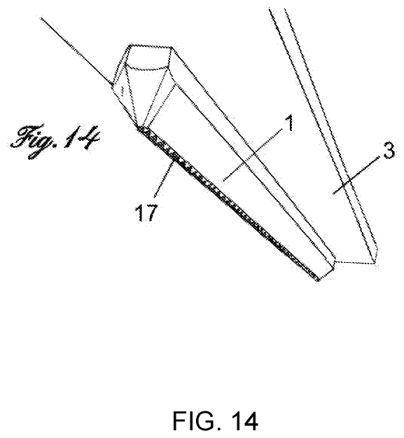

The best embodiment of the invention would most definitely be the third embodiment which can print by far the fastest. The third embodiment depicted in FIGS. 13, 14 and 23 could utilize for example 68 sections (16) at will with the help of separate extruders for each section (16) and allow for extreme detailing by just sweeping across the build surface (5) maybe once or twice. This embodiment can offer at its best, using an elongated nozzle (1) that is the width of the entire build surface (5), finishing a print layer by sweeping over the build surface only one time. It may need to use one of the sections (16) as if it were a traditional nozzle to fill in details after. It could also use an onboard traditional nozzle (14) if the machine has one in addition to the elongated nozzle (1), like depicted in FIG. 9. It would do this after that one first sweep to fill in any details it missed, but that would likely only take a few seconds more. A traditional FDM 3D printer would only have purged the nozzle with a thin line across the build surface in the same amount of time that the third embodiment could potentially finish an entire layer. A traditional printer often takes a few minutes or longer to finish one layer. An ender 3 which is a common traditional 3D printer that uses FDM technology has a print height of 9 inches approximately. The layer height minimum being arguably 0.1 mm. 9 inches in millimeters is 228.6 thus approximately 2,286 layers are the maximum for this printer. A common slicer shows 2492 layers for a solid cube that fills the entire build area. If it took 10 seconds to complete each layer, it would take about a week to finish this print. For a traditional printer like the Ender 3 it would take 85 days approximately according to the slicer. Traditional printers can print at about 8% of the speed that this embodiment of the invention can print at. This embodiment can thus print approximately 11.5 times faster than a traditional 3D printer that uses FDM technology such as the Ender 3. Other embodiments would be significantly less but still impressive depending on the size and shape of the print.

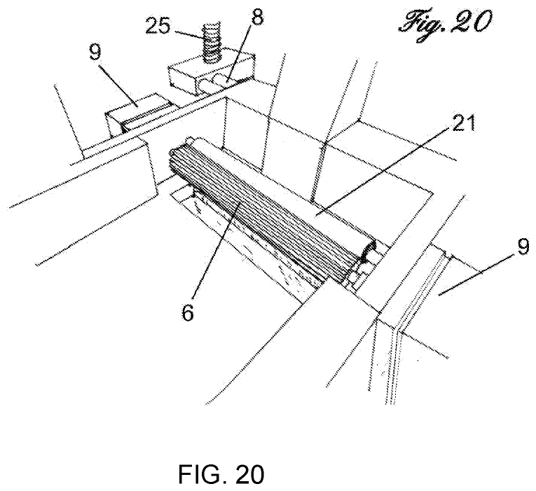

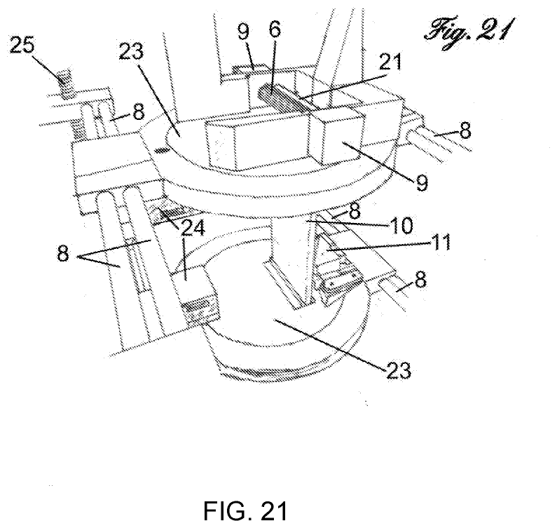

The elongated nozzle (1) could be detachable or be non-detachable from the rest of the elongated hot end. If it was non-detachable and there was a clog or other elongated nozzle (1) damage, the elongated hot end assembly would likely need to be replaced entirely. The fourth embodiment can rotate the elongated nozzle (1) and extruder assembly. The elongated nozzle (1) and hot end would be able to rotate using a rotating assembly that is on an X-axis track (8) below the extruder assembly which would be on it's own X-axis track (8) as depicted in FIGS. 20, 21 and 24. This rotating feature would likely only be used on embodiments that use some degree of elongated filament because for example the third embodiment depicted in FIGS. 13, 14, 15 and 16, would have so much fine control over what parts of the elongated nozzle (1) that filament is flowing out of that it wouldn't necessarily need to rotate to work fast and fill in differently orientated sections correctly. A motor (24) would turn the rotating assembly (23) for the hot end in unison with a motor (24) that would rotate the extruder assembly above, or one could do both.

### C. Extruder Assembly

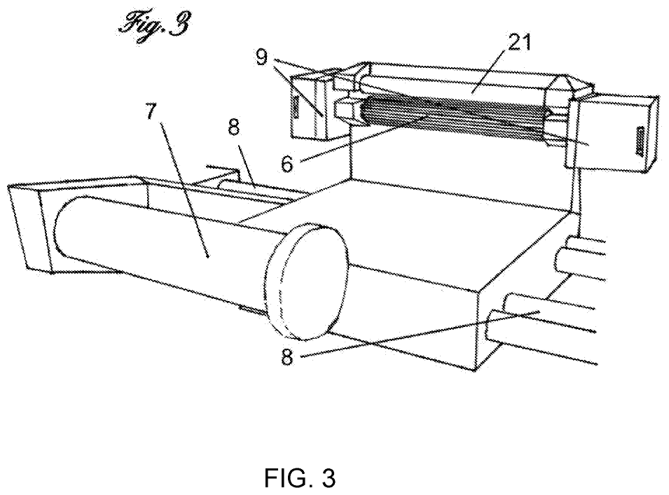

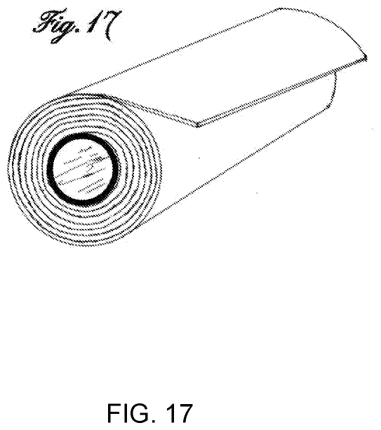

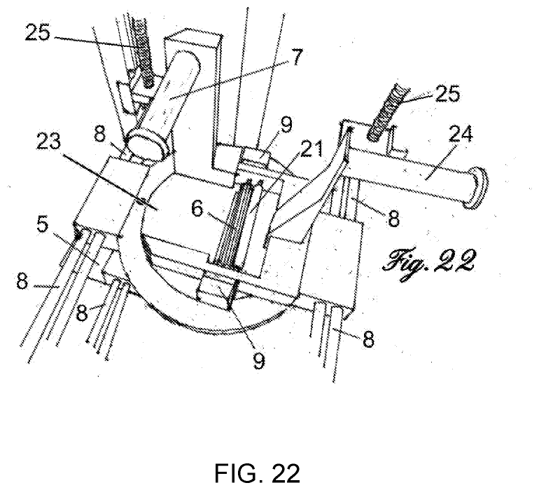

The extruder assembly pushes whatever shape and type of material through the tube (10), hot end and elongated nozzle (1) when printing. 4 different embodiments of the extruder are given in FIGS. 3, 4, 12, 15, 16, 20, 21 and 22. Depending on which embodiment of the printer is used, the extruder assembly may look different. In the most basic embodiment of the printer, the first embodiment, the printer would use elongated filament and thus the extruder could use a long geared shaft as an extruder feed gear (6) and a cylindrical rod as the filament feed guide (21) like depicted in FIGS. 3, 4 and 5. Two extruder motors (9) could be placed on either side of the extruder feed gear (6) to turn the extruder feed gear (6) and push the elongated filament through. This extruder assembly may need to be on an X-axis track (8) that is behind the elongated nozzle (1) and hot end assembly X-axis track (8). The extruder assembly would also likely need to move on the X-axis in unison with the elongated nozzle (1) and hot end assembly on the X-axis track in front of it, as to not damage the more rigid elongated connection tube (10) going across from the extruder, to the top of the hot end where it connects in the elongated tube coupler/coupling (22). For that embodiment the filament would come in rolls instead of spools like depicted in FIG. 17.

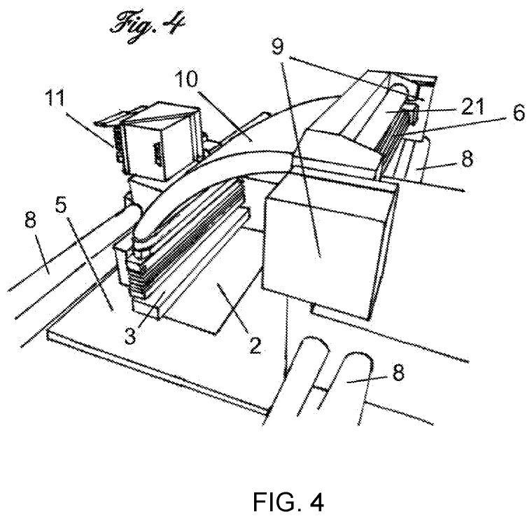

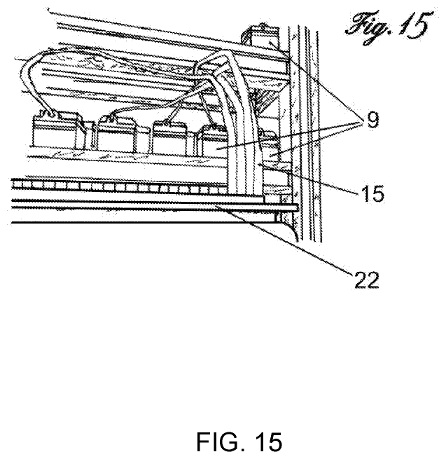

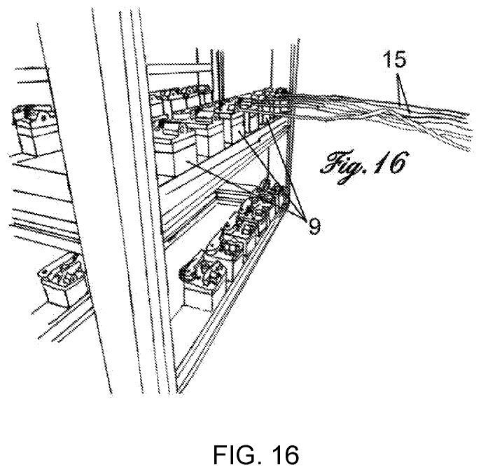

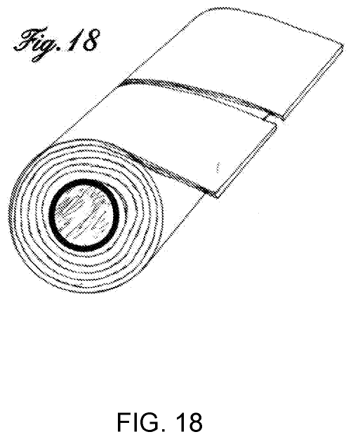

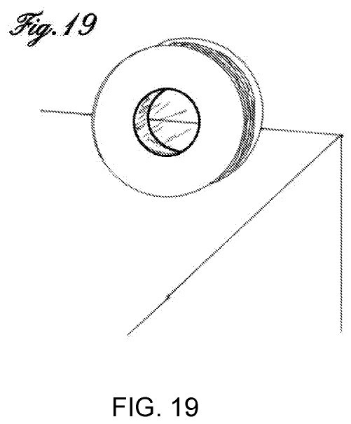

Another embodiment of the invention like depicted in FIGS. 10, 11 and 12 might have two extruding motors (9), 2 geared shafts as extruder feed gears (6) and 2 cylindrical rods used as filament feed guides (21). Then the roll of filament would have two smaller unconnected rolls of material on the roll. The roll of filament for this embodiment is depicted in FIG. 18. The two smaller rolls would allow the printer to extrude one half of the elongated nozzle (1) while not extruding the other half or could extrude both at the same time. Having this control would make it easier to fill in parts that might be too small for the full size elongated nozzle (1) to correctly fill in. This embodiment would decrease the amount that the printer would have to switch to an onboard traditional nozzle (14) if the printer has one. This embodiment would also likely need the extruder assembly to be on a X-axis track (8) behind the hot end assembly's X-axis track (8) and move in unison like the first embodiment. The third embodiment of the printer as depicted in FIGS. 13, 14, 15, 16 & 23 uses a large array of sections inside the elongated nozzle (1). For this embodiment, a large unit of extruders would be utilized. The Figures depict 68 sections (16) thus 68 extruders would be needed, if using 68 separate sections (16) inside the elongated nozzle (1). Each extruder could be the same used on traditional 3D printers. This large array of traditional extruder assemblies is depicted in FIGS. 15 and 16. This array of extruders may need a separate framed structure given how many there are. Each extruder would connect to a long tube (15) like they normally do on traditional printers and that tube (15) would go to the top of the elongated hot end and connect into the elongated tube coupling (22) which would have 68 or how ever many ports stemming out of it. To make room for this many tubes (15) going into the top of the elongated hot end assembly, the tubes (15) may need to be thinner than they normally are for traditional printers. This set up would use traditional filament as depicted in FIG. 19. This embodiment would need 68 spools or one for each divided nozzle section (16) that there is. Each spool could be a very small spool with only a small amount of material on it. Each of these spools could be full too but that would likely be unnecessary. The spools going into the extruders on the array could be mounted on the framed structure that is holding the extruders or be mounted on a separate third framed structure solely designated for the spools. A fourth embodiment as depicted in FIGS. 20, 21 and 24, would allow the extruder and elongated nozzle assemblies to rotate in unison. The extruder assembly would look identical to the one in the first embodiment (FIG. 3) except it would have the extruder feed gear (6) and filament feed guide (21) mounted in the floor of the extruder assembly and not in the side of it facing out. As well the extruder assembly would sit on a track above the hot end assembly, not behind it as in the first embodiment. The extruder assembly pushes whatever shape and type of material through the tube (10), tube coupling (22) and into the elongated hot end and out the elongated nozzle (1) when printing. Depending on which embodiment of the printer is used the extruder assembly may look different. In the most basic embodiment of the printer the extruder could utilize a long geared shaft as an extruder feed gear (6) and a cylindrical rod as a filament feed guide (21) to push the elongated filament (2) through the extruder. This embodiment is depicted in FIGS. 3 and 4. This embodiment would use a long extruder feed gear (6) and filament feed guide (21). The extruder may use stepper motors (9) or any other type of motors or automated device to turn the extruding system. The extruder motors (9) would turn the extruder feed gear (6). This extruder assembly may need to be on a separate X-axis track (8) behind the X-axis track (8) that the elongated nozzle (1) and hot end are on, like depicted in FIGS. 3, 4 and 5. The extruder assembly would also likely need to move in unison with the hot end assembly on it's X-axis track (8) as to not damage the more rigid elongated tube (10) that connects from the extruder to the top of the hot end, which is depicted in FIGS. 4, 8 and 9. If the extruder assembly wasn't lined up with the elongated nozzle (1) and hot end, the elongated tube (10) would likely twist and might break or prevent extrusion. The fourth embodiment depicted in FIGS. 20, 21 and 22 would use an almost identical extruder system to the first embodiment (depicted in FIG. 3) but would be above the hot end instead of behind it. As well the extruder feed gear (6) and filament feed guide (21) would be mounted in the bottom of the extruder assembly and not the side of it like in the first embodiment that is depicted in FIG. 3.

The second embodiments of the printer like depicted in FIGS. 10, 11 and 12 might have two extruder motors (9) (or other turning mechanisms) on opposite sides and 2 geared shafts as extruder feed gears (6) and two cylindrical rods as filament feed guides (21). Then the roll of filament would have two smaller unconnected rolls of material on the roll like depicted in FIG. 18. These two smaller rolls would allow the printer to extrude one half of the elongated nozzle (1) while not extruding the other half or it could extrude both simultaneously. Having this control would make it possible to fill in parts that might be too small for the full size elongated nozzle (1) to correctly fill in, without switching to an onboard traditional nozzle (14) given the printer has one.

The third embodiment of the printer as depicted in FIGS. 13, 14, 15, 16 and 23 allows a large array of sections inside the elongated nozzle (1). For this embodiment, a large array of extruders would be used. The Figures depict 68 sections thus 68 extruders would be needed if using 68 separate sections (16) inside the elongated nozzle (1). Each extruder would be the same used on normal 3D printers. This large array of extruder assemblies is depicted in FIGS. 15 and 16. This array of extruders may need a separate framed structure, given how many extruders there would be. Each extruder would connect to a long tube (15) like they normally do on traditional printers and that tube (15) would go to the top of the elongated hot end which would have 68 ports (Though only some are visible in the figures and only 4 ports on the hot end are connected to four of the extruders in the array.) on the top of the elongated tube coupling/coupler (22) or how ever many ports for the tubes (15) to slide into. To make room for this many tubes (15) going into the top of the elongated hot end, the tubes (15) may need to be thinner than they normally are with traditional FDM 3D printers. This set up would use traditional filament but it would need 68 spools or one for each divided section (16), for however many sections (16) there are. The third embodiment uses 68 sections (16). Each spool could be a very small spool with only a small amount of filament on it. Each of these spools could be full too, but that would likely be unnecessary. The spools going into the extruders on the array could be mounted on the framed structure that is holding the extruders in the array or on a separate third framed structure solely designated for the spools.

The best embodiment would be the third one which is depicted in FIGS. 15 and 16. That embodiment would be the fastest but that one would also take up the most room and potentially draw a decent amount of current, up to 380 watts if using 68 extruders like in the figures. That wattage would be just for the extruder array alone, given the extruder array uses typical stepper motors, the ones traditionally used in extruder assemblies on traditional FDM 3D printers.

In the fourth embodiment, the extruder assembly could also rotate on a rotating assembly (23) that slides on an X-axis track (8) above the hot end assembly which has its own rotating assembly (23). This embodiment would be good for allowing a large elongated nozzle (1) to get long print sections that are in different orientations than the hot end assembly is facing at default. The rotating system would likely but not necessarily only be used with elongated filament given the third embodiment (depicted in FIGS. 13, 14, 15 and 16) that uses traditional filament for each elongated nozzle (1) section (16) doesn't require rotating the elongated nozzle (1) and hot end to fill in differently oriented details or sections of a print. The rotating elongated nozzle (1), hot end and extruder embodiment is depicted in FIGS. 20, 21 and 22. The fourth embodiment (depicted in FIGS. 20, 21 and 24) would have the extruder assembly X-axis track (8) above the hot end X-axis track (8) instead of behind it like previously mentioned. The fourth embodiment would allow rotation and X and Z axis movement of the hot end assembly and extruder assembly in unison. This embodiment would need to be around 2 feet taller than the height of the tallest possible print height. The reason for this is the fact that the extruder assembly would sit above the hot end assembly on an X-axis track (8). Around 2 feet above the elongated nozzle (1) would be where the elongated filament would sit on its roll holder (7). This embodiment could easily be 4 feet tall. The rotation would allow more precision and more areas that the printer is able to fill in with the elongated nozzle (1) without having to switch to an onboard traditional nozzle (14) if the printer has one. A motor (24) would turn the rotating section (23) for the extruder assembly in unison with a motor (24) that would rotate the hot end assembly below it.

### D. Specialized Filament

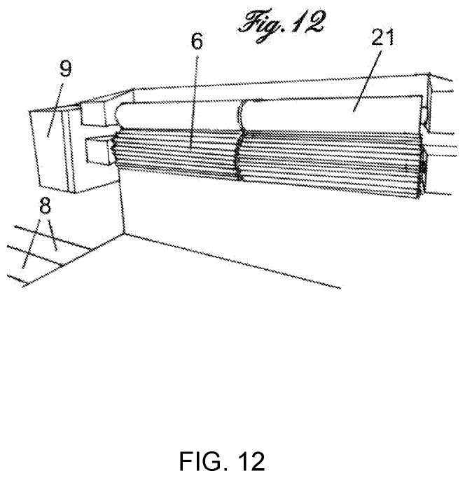

For the elongated nozzle (1) to print without a large array of divided sections (16) that are so tiny that they can all use traditional filament like depicted in FIGS. 13, 14 and 15, it will need a different shape filament that is long like the elongated nozzle (1) and hot end. This filament would come in rolls instead of spools as it would not be cord but a continuous ribbon of material. The roll of filament is depicted in FIG. 17. These rolls may look vaguely similar to commercial size rolls of toilet paper but would come in whatever filament or materials commonly used in FDM 3D printing just like normal spools of filament offer. Of course the rolls of material would likely be significantly thicker than toilet paper. This shape of filament would be different from the thin cord of filament traditional 3D printers use. This filament would look more like a roll of ribbon shaped filament than a spool of wire or cord shaped filament like previously mentioned which is why a specialized extruder is needed. The material/filament for the first embodiment depicted in FIGS. 1, 2, 3, 4, 5, 6, 7, 8 and 9 would come in rolls instead of spools like depicted in FIG. 17. These rolls that may look similar to rolls of duct tape or toilet paper like previously mentioned and would come in whatever material that is being used. For example a few possible materials might be PLA, ABS, NYLON, Etc. Any metal FDM 3D printer that uses an elongated nozzle (1) would use metal filament which would likely be limited to soft and low melting point metals but not necessarily. They may start off in the same materials currently available for traditional FDM 3D printers like those materials listed above. The rolls of material would usually be thicker than toilet paper or duct tape and more close to the thickness of the diameter of traditional filament that come in spools. This elongated shape of filament would obviously be different from the cord of filament traditional FDM 3D printers use. This filament would look like a roll of paper towels or tape instead of a spool of wire or cord. The second embodiment that is depicted in FIGS. 10, 11 and 12 would use the filament depicted in FIG. 18. That filament would have two separate rolls on a roll. Half of the roll would have a roll and the other would have a roll of equal size. When printing, a slight seam may be visible between where each section (16) was. The seam would be where the separator (17) was in the elongated nozzle (1). The first embodiment of filament that comes in a roll depicted in FIG. 17, would work with the embodiment depicted in FIGS. 1, 2, 3, 4, 5, 6, 7, 8 and 9. The second embodiment of the filament comes in a roll with two separate rolls on it like depicted in FIG. 18. The extruder assembly for that embodiment is depicted in FIG. 12. The third embodiment uses traditional spools of filament and doesn't use an elongated filament but instead uses traditional filament that traditional FDM 3D printers use. It would need a spool for each section (16) in the elongated nozzle (1). The Figures depict an elongated nozzle (1) with 68 sections thus 68 spools would be necessary for the third embodiment to function fully. Each spool could have a small amount of filament on it given each section (16) will only be doing a little bit of printing in comparison to the whole print. When printing, a slight seam may be visible between where each section (16) was, the seam would be where the separators (17) were in the elongated nozzle (1). The fourth embodiment would use the same filament as the first embodiment. That filament is depicted in FIG. 17.

### E. Motherboard, Axis Track Systems and Electronics

The motherboard controls the x, y and z axis movement and everything else on the printer, just like on a traditional FDM 3D printer. The frame and systems that allow the axes to move can likely be similar if not practically identical to parts used with any other traditional FDM 3D printer. The first two embodiments (depicted in FIGS. 1, 2, 3, 4, 5, 5, 7, 8 & 9 and 8, 9, 10, 11 & 12) would likely use a second X-axis track (8) for the extruder assembly that would be behind the elongated nozzle (1) and hot end assemblies X-axis track (8). The extruder X-axis track (8) obviously wouldn't be present on traditional printers. The systems used to move the axes may be very similar to those used on traditional FDM 3D printers; they could use the same belts, tracks, threaded rods and non-threaded rods that a traditional printer might use. The Z-axis could obviously also use the same systems and components like threaded rods but may make use of more motorized Z-axis threaded rods (25) then usually used on traditional printers. 2 motorized threaded Z-axis rods (25) are used to lift the hot end X-axis track (8) and 4 are used to lift the extruder assembly X-axis track (8) that is behind the X-axis track (8) that the elongated hot end is on in some of the embodiments, as depicted in the Figures, given the assemblies it will be lifting will be heavier than those on traditional printers.

The second X-axis track (8) (that is behind the hot end X-axis track (8) which is depicted in FIGS. 3, 4, 5 and 12) can be omitted in any embodiment that doesn't use elongated filament but instead uses a large array of traditional or smaller than traditional nozzle sized channels/sections (16) inside an elongated nozzle (1) like the third embodiment that is depicted in FIGS. 13, 14, 15, 16 and 23. The reason for this is that the individual traditional tubes (15) can turn and twist like on a bowden extruder on traditional printers while an elongated tube (10) cannot. The Z-axis does not need to use threaded rods but many traditional printers use threaded rods to lift the nozzle on the Z-axis. The printer could also use any other system to lift the Z-axis like belts and or tracks.

The motherboard(s) controls the motors that move the x, y and z axis. It also controls the heating element, gauges temperature using any on onboard temperature sensors inside the nozzle and hot end assembly and does other things required for the function of the printer. The motherboard would be able to connect to a computer (or flash drive, sd card, etc) through some type of interface just like traditional printers do. Software would tell the printer's motherboard when, how and for what sections to use the elongated nozzle (1) and when to use an onboard traditional nozzle (14) if the printer has one. The printer would be limited to simple low detail prints if an onboard traditional nozzle (14) wasn't present to do smaller or detailed sections. This is the case except in embodiments that allow the elongated nozzle (1) to accomplish greater detail without the help of an on board traditional nozzle (14). One embodiment that allows fine detail without the help of an on board traditional nozzle (14) is the third embodiment, depicted in FIGS. 13, 14, 15 and 16. That is why it is the best embodiment of the invention but only in means of performance. That embodiment could take up two tables which is a decent amount of space compared to the space traditional printers take up. The first two and fourth embodiments would take up only a bit more space than a traditional printer would; while the third embodiment would take up about the space of 3 traditional printers because of the extruder array framed structure and the framed structure holding the array of spools (if the spools can't be mounted on the extruder array framed structure). If the spools were mounted on the extruder array framed structure it might only take up the room of two traditional printers.

The motherboard might have any number of connectors or parts to allow it to connect to whatever number of components in whatever embodiment. The slicers currently available would have to have software updates to be compatible with elongated nozzles (1) and different types and sizes of elongated nozzles (1). For the first two embodiments and the fourth embodiment, the slicer would use the elongated nozzle (1) for large uninterrupted sections of a print layer. If the printer had an onboard traditional nozzle (14) it would have it's own extruder which would probably be a direct drive (like depicted in the FIGS. 4, 8 and 9) but could be a bowden extruder as well or any other type of extruder. If the printer has an on board traditional nozzle (14) it would use it for parts that the slicer would mark for it to fill in. The slicer would also mark sections for the elongated nozzle (1) to fill in. The printer would then use the on board traditional nozzle (14) for sections that are too small or detailed for the elongated nozzle (1) to accomplish correctly. If the printer doesn't have a traditional nozzle (14) and only an elongated nozzle (1), the slicer would inform the user that their machine isn't able to complete the model if the model they are trying to slice has any details that the elongated nozzle (1) can't accomplish on it's own.

The third embodiment depicted in FIGS. 13, 14, 15 and 16 would likely need a controller board for each row of extruder assemblies in the extruder array. Those row controller boards would connect to a main extruder array control board. Then that extruder array control board would connect to the main printer motherboard, but any other orientation or control system could be used to coordinate the extruder array and the rest of the printer.

The mother board for an elongated nozzle 3D printer would likely need to be different but some traditional 3D printer motherboards may still work for some of the embodiments such as the first embodiment that is depicted in FIGS. 1, 2, 3, 4, 5, 6, 7, 8 and 9 and the second which is depicted in FIGS. 8, 9, 10, 11 and 12. (8 and 9 show how both embodiments might look on the outside but embodiment two has a separation in the middle of the elongated nozzle (1) and hot end as well as the tube (10) but isn't visible in the Figures as it wouldn't necessarily be noticeable from the outside) As well traditional 3D printer motherboards might work with the fourth embodiment depicted in FIG. 20.

Standard printer motherboards likely wouldn't work with the third embodiment (depicted in FIGS. 13, 14, 15 and 16.) but they potentially could if enough intermediary boards were used to control the large array of extruders without a direct connection from the main motherboard to each extruder. For example if each row of extruders in the array had a row board which each extruder in the row connected to and then the row board connected to an array board; which all the row boards connect to. Then if the array board has one connection to the main printer mother board it may work with traditional 3D printer motherboards. Though traditional 3D printer motherboards may work with different firmware installed, it may be better to have specialized motherboards designed for the printers that use elongated nozzles (1).

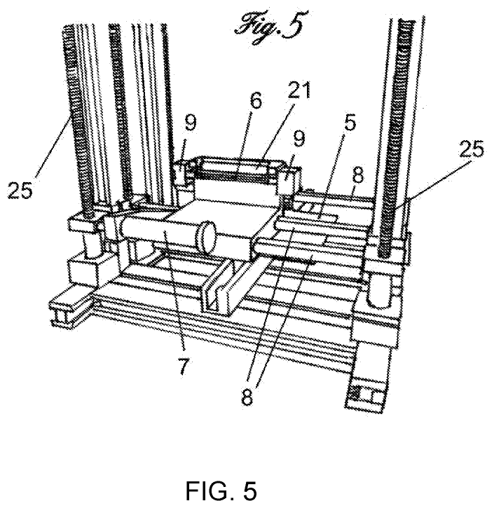

In FIGS. 5, 20, 21, 22 and 23 the Z-axis threaded rods (25) traditionally used to provide lift can be seen. These may not be much different then traditional FDM printers. One difference is more motors and Z-axis threaded rods (25) are used in the Figures than most traditional printers have. The reason for this is because the assemblies it has to lift are significantly heavier. Some traditional 3D printers like the Ender 3 use only 1 Z-axis threaded rod (25) to lift the hot end assembly. The first, second and fourth embodiments of the invention have 2 used to lift each X-axis track (8) on the z axis. The extruder assemblies in embodiment 1, embodiment 2 and embodiment 4 all use 4 threaded rods and motors to lift them on the Z-axis. More or less rods (25) and motors (or other lifting components) can be used if needed, more are unlikely to be needed.

### F. Connections of Main Elements and Sub-Elements of Invention

The hot end and elongated nozzle (1) require a significant temperature to melt whatever material is being pushed through it. A heating element (19) is used to melt the material once it reaches a certain point in the hot end. A heat sink (18) and heat break (4) are used to prevent the material reaching a significant temperature to melt before reaching the heater block (3). The heater block (3) is what heats up because the heating element (19) is inside it. A temperature sensor, usually a thermistor, is used to check the temperature which is also inside the heater block (3). Multiple temperature sensors could be used to evaluate the temperature of the elongated hot end. These things will be somewhat different due to the elongation of some of the components. Most things will be quite similar to traditional printers given the one main difference of elongation of some components.

The extruder assembly as well is somewhat similar to traditional printers. A turning mechanism like extruder motors (9), an Extruder feed gear (6) and Filament Feed guide (21) are used. Depending on the embodiment of the machine the extruder feed gear (6) and Filament Feed guide (21) may be elongated like in the first, second and fourth embodiments where there is only one or two extruder feed gears (6) and filament feed guides (21). The exception to this is the third embodiment which uses an array of traditional extruders and non-elongated filament. If an onboard traditional nozzle (14) is present, the machine may have margins between the frame and build surface edge to allow the end of the elongated nozzle (1) to be able to move enough one way to let the traditional nozzle (14) reach both ends of the build surface on the X-axis without the elongated nozzle (1) hitting the frame. This margin can be seen in FIG. 5. If the traditional nozzle (14) is on a separate X-axis track (8) then the elongated nozzle (1) and hot end, then such a margin would not be necessary.

### G. Alternative Embodiments of Invention

The printer can have divided sections going down through the hot end, elongated nozzle (1) and connection tube (10). Any number of divided sections can be used or it can have none at all. The most basic embodiment only has 1 section in the elongated nozzle (1) and hot end like depicted in FIGS. 6 and 7. Any number of divided sections can be used which may make use of different extruding systems and filaments. Four examples are given but the four examples aren't the only four possibilities. A mechanism could also be used to lift the elongated hot end on the hot end assembly up away from the build surface a few mm to prevent too much heat coming off the elongated hot end and hitting the print layer. The printer must at least have 1 elongated nozzle (1) but other systems including the extruder and all other supporting systems can be of any orientation, shape, design or type that function with the elongated nozzle (1). 4 example embodiments are given in the figures but they are not the only 4 possibilities. The best embodiment is the third embodiment, given it prints the fastest and is the most accurate. The second best embodiment is the fourth embodiment.

### H. Operation of Each Embodiment

The printer will use the elongated nozzle (1) to lay down long sections of filament (2) in a matter of seconds. The printer will use new slicer software compatibility updates or newly designed slicers to decide which sections of a print layer to use the elongated nozzle (1) for and which to use an on board traditional nozzle (14) for, if the printer also has one. The user will use a compatible slicer to slice the model they wish to print as they would with a traditional FDM 3D printer. They will connect the computer or get the file to the printer in another manner such as an sd card, wireless systems or any other method that the printer allows. For the embodiments that use elongated filament, users will place the roll of elongated filament onto the filament roll holder (7). They will then take the end of the filament roll and push it through the extruder in between the extruder feed gear (6) and filament feed guide (21) and down the elongated tube (10) until it starts oozing out of the elongated nozzle (1). This is the same way you set up traditional printers to print and nothing would be that different. If the printer has an onboard traditional nozzle (14) they will also take a traditional spool of filament and put it on the traditional filament spool holder (24) and feed the filament into the traditional extruder (11) which goes to the traditional nozzle (14), like they would on any other traditional FDM 3D printer. Then the printer can be turned on and any peripheral or controls can be used to specify parameters if the printer has any. If the printer doesn't have any controls like a screen and nob then the printer likely would be controlled from the computer or automatically print the file uploaded like traditional FDM 3D printers allow. The printer would start to print, the printer could accomplish infill by lining up with a place where a line of infill should be and start extruding for a second without moving, then move down to where that section it extruded ends and repeat. Then any sections that are left at the end that are too short for the elongated nozzle (1) to accomplish, could be done with the traditional nozzle (14) if the printer also has one. The printer's function would be limited to simple shapes and structures without details if a traditional nozzle (14) isn't present on the machine in addition to the elongated nozzle (1). The exception to this is the third embodiment which could accomplish details without a traditional nozzle (14).

The third embodiment would have a lot more set up required than traditional printers or other embodiments. First a tube (15) for each extruder in the extruder array would be connected to each extruder. The ends would be connected to the ports at the top of the hot end, on the elongated tube coupling (22). A spool will be needed for each section (16) there is in the elongated nozzle (1), the third embodiment depicts 68, thus 68 spools of filament would be required. Each spool could be small given each section (16) in the elongated nozzle (1) doesn't need much filament itself. Each respective spool would need to be fed into its extruder and down the tube (15) to the hot end until each section (16) in the elongated nozzle (1) has some filament ooze out. Any excess filament could be brushed off the elongated nozzle (1), then the print could be started. When printing the elongated nozzle (1) may stop to retract filament from certain sections and prepare to extrude others. If the elongated nozzle (1) was the same width as the build surface it could finish a layer in a few seconds. An estimate of the longest any print could take using the third embodiment is 2.5 hours with a 0.3 mm layer height and 14 hours using a layer height of 0.1 mm, given the maximum print height is approximately 10 inches and the build surface (5) length is approximately 9 inches. These are rough approximations, if there were 2500 layers and it only took 20 seconds to finish each layer it would take 50,000 seconds to finish a solid cube filling the entire build area which is the largest print possible on any printer. To put this into perspective, it would take 85 days or longer for a traditional FDM 3D printer like the Ender 3 to print a solid cube with full infill that fills the entire build area. A 0.3 mm layer height would allow the third embodiment of this invention to do that in 2.5 hours. The other embodiments would have a maximum print time that would be mostly dependent on the shape and details in the file being printed.

Unless otherwise defined, all technical and scientific terms used herein have the same meaning as commonly understood by one of ordinary skills in the art to which this invention belongs. Although methods and materials similar to or equivalent to those described herein can be used in the practice or testing of the elongated nozzle FDM 3D printer, suitable methods and materials are described above. All publications, patent applications, patents, and other references mentioned herein are incorporated by reference in their entirety to the extent allowed by applicable law and regulations. The elongated nozzle FDM 3D printer may be embodied in other specific forms without departing from the spirit or essential attributes thereof, and it is therefore desired that the present embodiment(s) be considered in all respects as illustrative and not restrictive. Any headings utilized within the descriptions are for convenience only and have no legal or limiting effect.

What is claimed is:

1. An apparatus for making three-dimensional physical objects of a predetermined shape by sequentially depositing multiple layers of solidifying material on a base member in a desired pattern, comprising:
An elongated nozzle of any size or degree of elongation which may or may not have divided sections within it that allow independent extrusion of melted material for each section.
One or multiple extruding systems designed to extrude elongated filament through an elongated nozzle or an array of traditional extruders that can independently extrude traditional filament through each of multiple divided channels in an elongated nozzle.

2. An apparatus as defined in claim 1 wherein:
An elongated nozzle is heated entirely as one piece and any present divided sections have little to no unheated space between them and have no more than the size of three section's width or diameter in spacing between each section.

3. An apparatus as defined in claim 1 wherein:
An elongated nozzle is only used with elongated filament.

4. An apparatus as defined in claim 1 wherein:
An elongated nozzle is used solely with traditional filament and divided sections and not elongated filament.
